(19) United States
(12) Patent Application Publication
(10) Pub. No.: US 2017/0049200 A1
(43) Pub. Date: Feb. 23, 2017

(54) Desk Organizer

(71) Applicant: United Comb & Novelty Corporation, Leominster, MA (US)

(72) Inventors: Ronald Audet, North Smithfield, RI (US); Rebecca Foster, West Lebanon, NH (US)

(21) Appl. No.: 15/236,420

(22) Filed: Aug. 13, 2016

Related U.S. Application Data
(60) Provisional application No. 62/207,615, filed on Aug. 20, 2015.

(51) Int. Cl. A45C 11/34; B43M 99/00; B65D 21/02

(52) U.S. Cl. CPC A45C 11/34; B65D 21/0233; B43M 99/008; A45C 2011/002

(57) ABSTRACT

A one-piece, unitary desk organizer with one or more relatively deep cups that are constructed and arranged to hold relatively long and thin items such as pens, pencils and scissors, and a cell phone/smartphone-receiving receptacle that has an opening that provides for access to a connector or jack on the bottom of the phone so that one or more cords can be run to the phone.

### CROSS-REFERENCE TO RELATED APPLICATION

This application claims benefit from U.S. Provisional Patent Application No. 62/207,615, filed on Aug. 20, 2015, the contents of which are incorporated herein by reference.

### BACKGROUND

This disclosure relates to an organizer for pens, pencils and other office supplies and implements.

Desk organizers hold and organize pens, pencils, clips and other office supplies and implements.

### SUMMARY

Featured in this disclosure is a desk organizer that is constructed and arranged to hold office supplies such as pens/pencils/scissors, business cards, a cell phone and paper clips/binder clips. The desk organizer is designed to allow a cord to run to the cell phone underneath the desk organizer, up through the bottom to the connector/jack of the phone. Also, a number of desk organizers can nest (i.e., stably stack one on another) to save space in shipment, storage and on retail shelves.

All examples and features mentioned below can be combined in any technically possible way.

In one aspect, a one-piece, unitary desk organizer includes one or more relatively deep cups that are constructed and arranged to hold relatively long and thin items such as pens, pencils and scissors, and a cell phone/smartphone-receiving receptacle that has an opening that provides for access to a connector or jack on the bottom of the phone so that one or more cords can be run to the phone.

Embodiments may include one of the following features, or any combination thereof. The desk organizer may also include a shallow slightly backwardly angled cavity that is constructed and arranged to hold business cards. The cavity may have a ridged bottom shelf. The angled cavity may be framed on two lateral sides by a backwardly-angled flat face area against which a cell phone or smartphone can rest, where the flat face area is adjacent to the cell phone/smartphone-receiving receptacle.

Embodiments may include one of the following features, or any combination thereof. The desk organizer may also include a space below the cups, to provide room to run a cord to the phone. The desk organizer may also include a rear wall adjacent to the cups, and an opening in the rear wall to allow a cord to enter the space. The desk organizer may also include a shallow well that can hold paper clips, binder clips and other small loose items. The cups may be in a rear portion of the organizer, the well may be in a front portion of the organizer, and the receptacle may be in a mid portion of the organizer that meets and is between the rear portion and the front portion. The front portion may have a top that is angled slightly downwardly from where it meets the mid portion to a front of the organizer.

Embodiments may include one of the following features, or any combination thereof. The desk organizer may also include a rear wall adjacent to the cups and having first and second lateral edges, and first and second sidewalls that are each coupled to one of the lateral edges, wherein the rear wall and sidewalls are angled outwardly to allow a number of identical organizers to be stacked in a nested fashion. The outward angle may be about 4 degrees.

In another aspect, a one-piece, unitary desk organizer includes one or more relatively deep cups that are constructed and arranged to hold relatively long and thin items such as pens, pencils and scissors, and a space below the cups, to provide room to run a cord to the phone, a rear wall adjacent to the cups and having first and second lateral edges, and first and second sidewalls that are each coupled to one of the lateral edges, wherein the rear wall and sidewalls are angled outwardly (at perhaps about 4 degrees), to allow a number of identical organizers to be stacked in a nested fashion, and an opening in the rear wall to allow a cord to enter the space, a cell phone/smartphone-receiving receptacle that has an opening that provides for access to a connector or jack on the bottom of the phone so that one or more cords can be run to the phone, a shallow slightly backwardly angled cavity that is constructed and arranged to hold business cards, wherein the angled cavity is framed on two lateral sides by a backwardly-angled flat face area against which a cell phone or smartphone can rest, where the flat face area is adjacent to the cell phone/smartphone-receiving receptacle, and a shallow well that can hold paper clips, binder clips and other small loose items. The cups are in a rear portion of the organizer, the well is in a front portion of the organizer, and the receptacle is in a mid portion of the organizer that meets and is between the rear portion and the front portion. The front portion has a top that is angled slightly downwardly from where it meets the mid portion to a front of the organizer. The cavity may have a ridged bottom shelf.

### BRIEF DESCRIPTION OF THE DRAWINGS

FIG. 1 is a front perspective view of a desk organizer.

FIG. 2 is a bottom rear perspective view thereof.

FIG. 3 is a top rear perspective view thereof.

FIG. 4 is a top view thereof.

FIG. 5A is a front view thereof.

FIG. 5B is a cross-section taken along line A-A of FIG. 5A.

FIGS. 6A and 6B are side and front views, respectively, of four identical nested desk organizers.

FIG. 6C is a cross-section taken along line B-B of FIG. 6B.

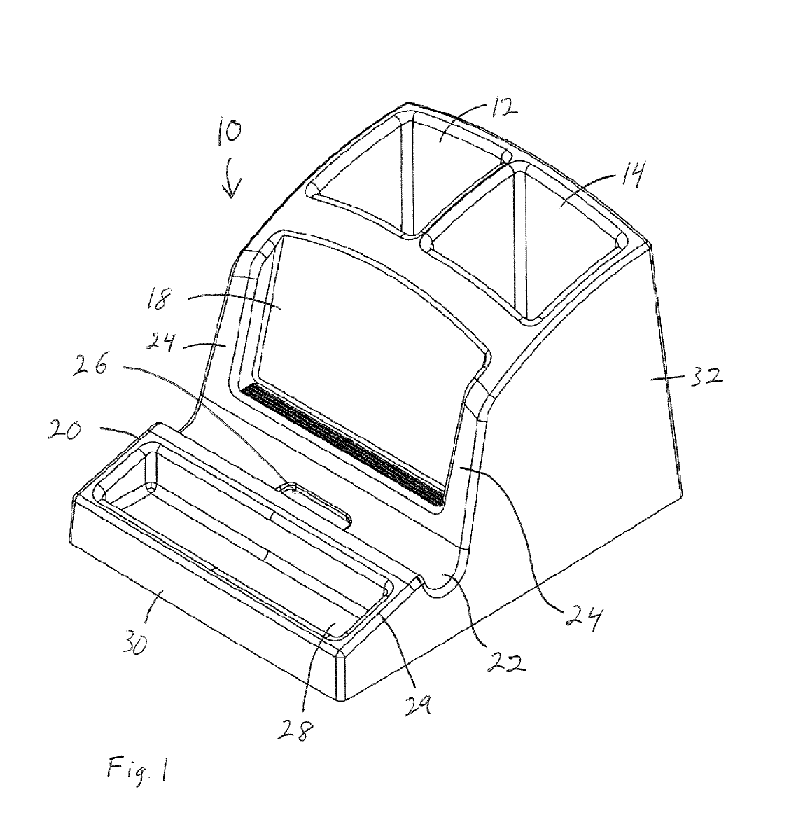

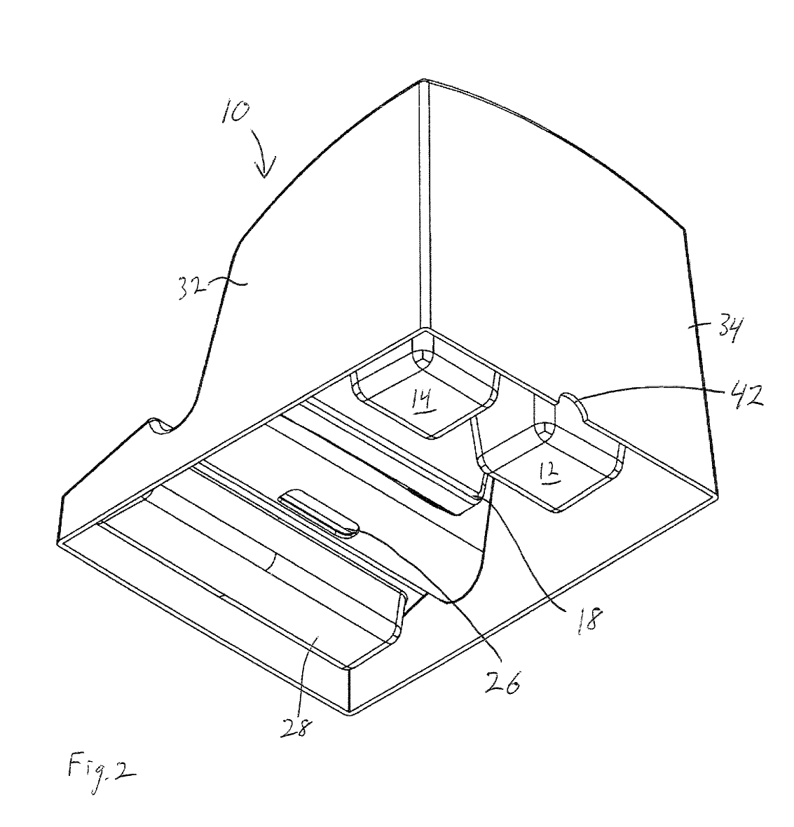

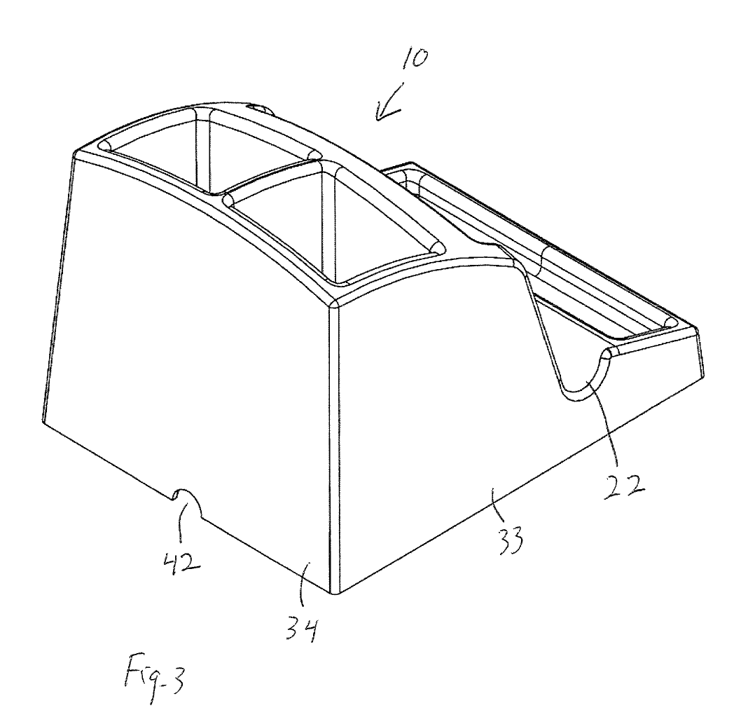

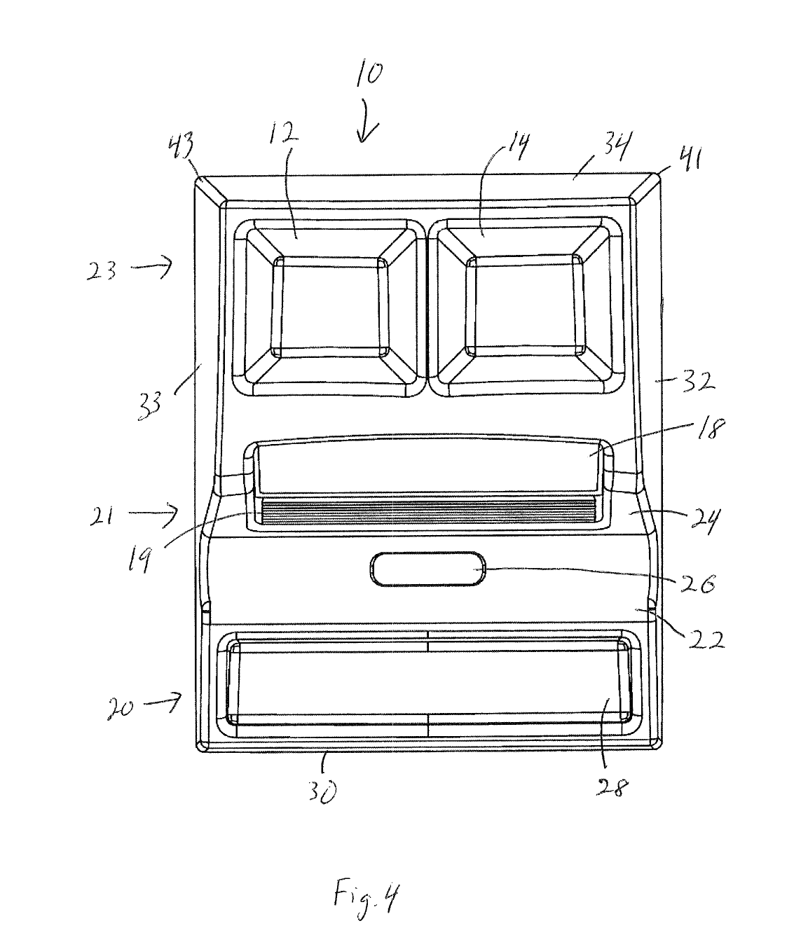

### DETAILED DESCRIPTION

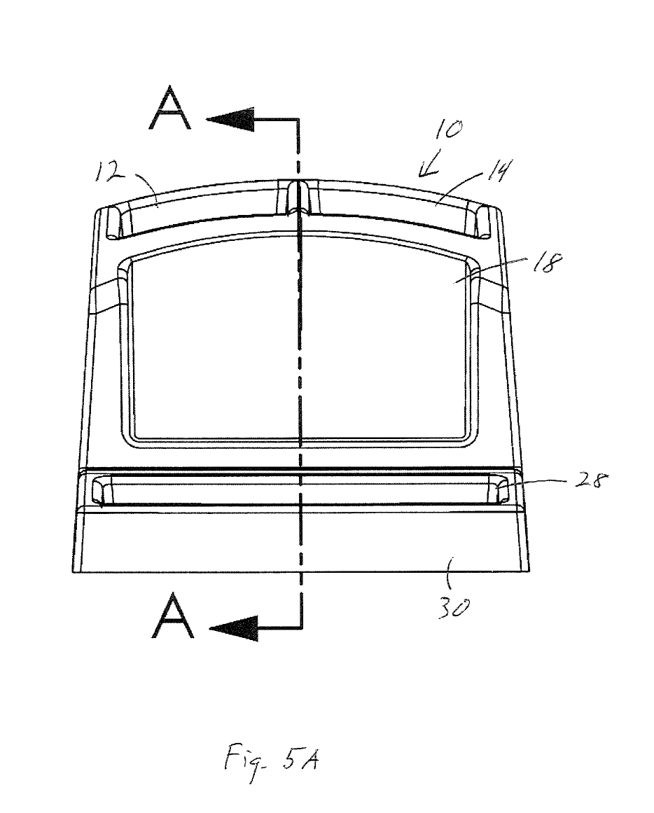

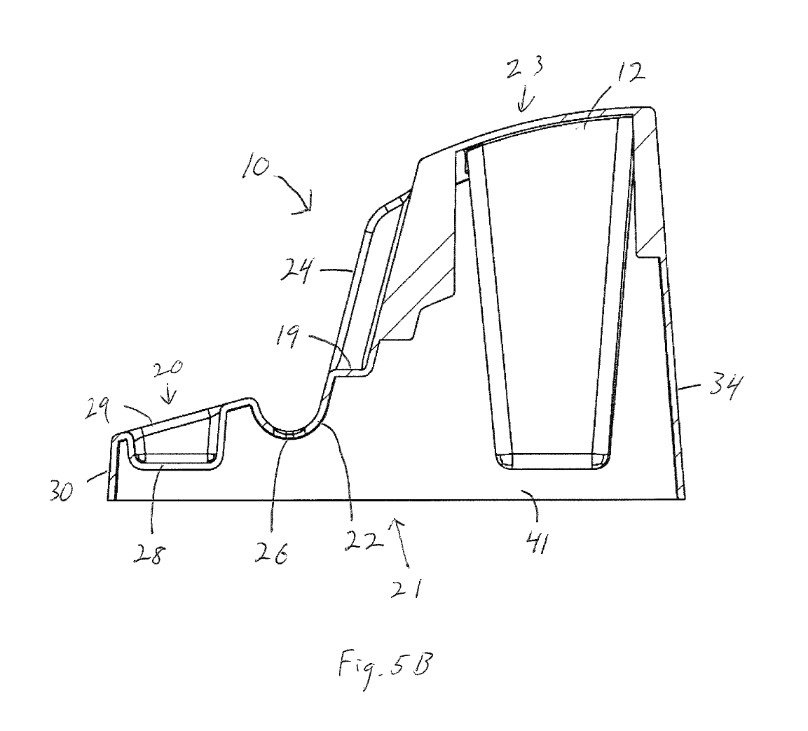

Desk organizer 10 is preferably a one-piece injection molded item which can be made from any appropriate plastic such as polystyrene, polyethylene or polypropylene, for example. Rear portion 23 includes relatively deep, inwardly-tapered cups or cavities 12 and 14 that can hold longer items such as pens, pencils and scissors. Shallow slightly backwardly angled cavity 18 (located in mid portion 21) is designed to hold business cards; its bottom shelf 19 can be ridged and it may (or may not) include a slight lip at the front to help keep cards from sliding off. Cavity 18 is framed on two lateral sides by flat face area 24, which is angled slightly backwardly, perhaps at the same angle as cavity 18. A cell phone or smartphone can sit upright (at a slight backward angle as determined by the angle of area 24 from the vertical) in generally U-shaped shallow receptacle 22, with its back against support area 24. Opening 26 in the bottom of receptacle or well 22 allows access to a connector or jack on the bottom of the phone so that one or more cords (not shown) can be run to the phone (e.g., from a wall charger). As shown in FIG. 5B, there is a space 41 generally below cups 12 and 14 (below the structures in rear portion 23 and mid portion 21), to provide room to run cords. Opening 42 in rear wall 34 allows the cord(s) to enter space 41. Front portion 20 of organizer 10 includes shallow well 28 that can hold paper clips, binder clips and other small loose items. Front wall 30 is shown in FIG. 5B. Top 29 of front portion 20 can be angled slightly downward from back to front as shown in FIG. 5B.

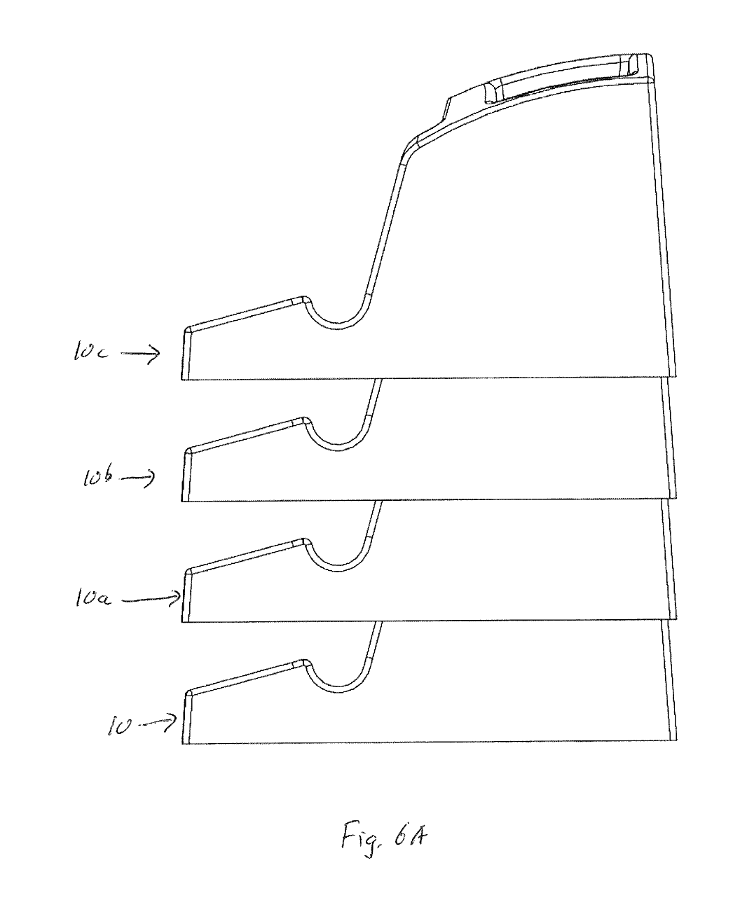

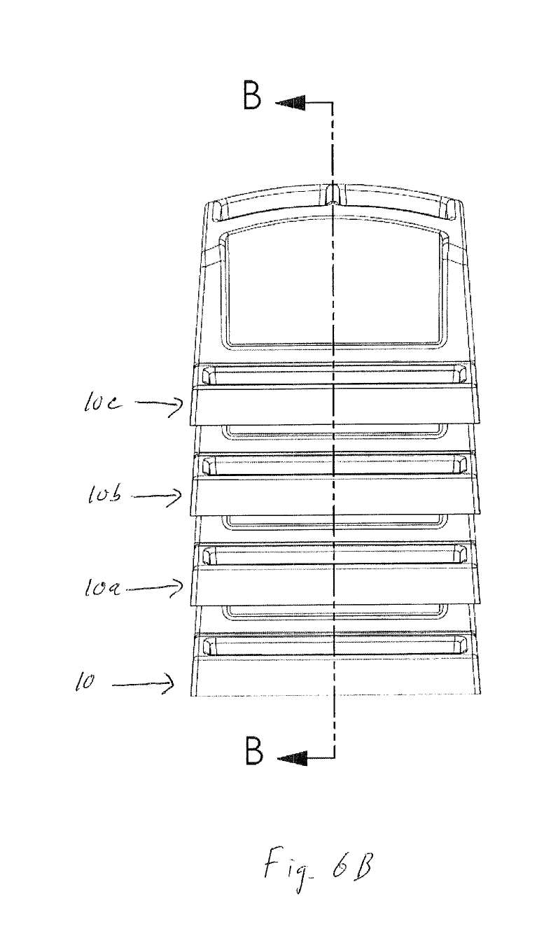

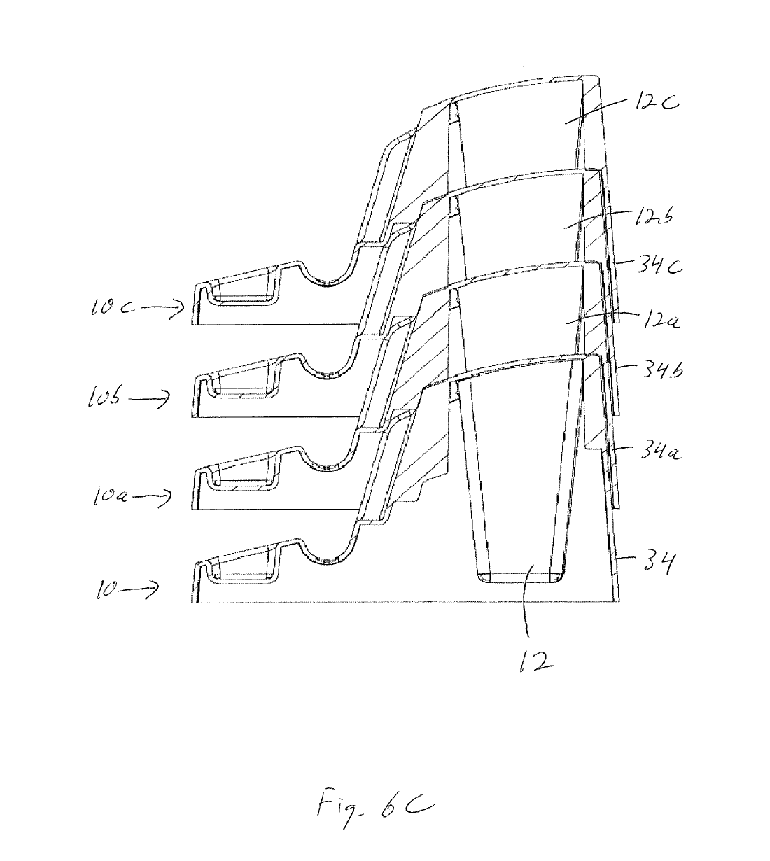

As shown in FIGS. 6A-6C, a number of identical organizers (four, labeled 10, 10a, 10b and 10c in this non-limiting example) can be stacked in a nested fashion. Rear wall 34 has first and second lateral edges 41 and 43. Sidewalls 32 and 33 are coupled to edges 34a and 34b, respectively. The inward taper of cavities 12 and 14 along with the outward taper of sidewalls 32 and 33 and rear wall 34 (which in one non-limiting example lie at a draft angle of about 4 degrees, but more generally can be any draft angle, but typically from about 2 degrees to about 6 degrees) allows the organizers nest one within another as shown, while the taper of cavities 12 and 14 (that allows them to fit one within another) along with the angle of surface/face area 24 allows multiple point contact between adjacent organizers that helps to hold the stack in a stable configuration. See nesting of cavities 12, 12a, 12b, and 12c and rear walls 34, 34a, 34b and 34c of organizers 10, 10a, 10b and 10c, respectively, FIG. 6C.

A number of implementations have been described. Nevertheless, it will be understood that additional modifications may be made without departing from the scope of the inventive concepts described herein, and, accordingly, other embodiments are within the scope of the following claims.

What is claimed is:

1. A one-piece, unitary desk organizer, comprising:
one or more relatively deep cups that are constructed and arranged to hold relatively long and thin items such as pens, pencils and scissors; and
a cell phone/smartphone-receiving receptacle that has an opening that provides for access to a connector or jack on the bottom of the phone so that one or more cords can be run to the phone.

2. The desk organizer of claim 1, further comprising a shallow slightly backwardly angled cavity that is constructed and arranged to hold business cards.

3. The desk organizer of claim 2, wherein the cavity has a ridged bottom shelf

4. The desk organizer of claim 2, wherein the angled cavity is framed on two lateral sides by a backwardly-angled flat face area against which a cell phone or smartphone can rest, where the flat face area is adjacent to the cell phone/smartphone-receiving receptacle.

5. The desk organizer of claim 1, further comprising a space below the cups, to provide room to run a cord to the phone.

6. The desk organizer of claim 5, further comprising a rear wall adjacent to the cups, and an opening in the rear wall to allow a cord to enter the space.

7. The desk organizer of claim 1, further comprising a shallow well that can hold paper clips, binder clips and other small loose items.

8. The desk organizer of claim 7, wherein the cups are in a rear portion of the organizer, the well is in a front portion of the organizer, and the receptacle is in a mid portion of the organizer that meets and is between the rear portion and the front portion.

9. The desk organizer of claim 8, wherein the front portion has a top that is angled slightly downwardly from where it meets the mid portion to a front of the organizer.

10. The desk organizer of claim 1, further comprising a rear wall adjacent to the cups and having first and second lateral edges, and first and second sidewalls that are each coupled to one of the lateral edges, wherein the rear wall and sidewalls are angled outwardly to allow a number of identical organizers to be stacked in a nested fashion.

11. The desk organizer of claim 10, wherein the outward angle is about 4 degrees.

12. A one-piece, unitary desk organizer, comprising:
one or more relatively deep cups that are constructed and arranged to hold relatively long and thin items such as pens, pencils and scissors, and a space below the cups, to provide room to run a cord to the phone;
a rear wall adjacent to the cups and having first and second lateral edges, and first and second sidewalls that are each coupled to one of the lateral edges, wherein the rear wall and sidewalls are angled outwardly to allow a number of identical organizers to be stacked in a nested fashion, and an opening in the rear wall to allow a cord to enter the space;
a cell phone/smaxtphone-receiving receptacle that has an opening that provides for access to a connector or jack on the bottom of the phone so that one or more cords can be run to the phone;
a shallow slightly backwardly angled cavity that is constructed and arranged to hold business cards, wherein the angled cavity is framed on two lateral sides by a backwardly-angled flat face area against which a cell phone or smartphone can rest, where the flat face area is adjacent to the cell phone/smartphone-receiving receptacle; and
a shallow well that can hold paper clips, binder clips and other small loose items;
wherein the cups are in a rear portion of the organizer, the well is in a front portion of the organizer, and the receptacle is in a mid portion of the organizer that meets and is between the rear portion and the front portion, and wherein the front portion has a top that is angled slightly downwardly from where it meets the mid portion to a front of the organizer.

13. The desk organizer of claim 12, wherein the cavity has a ridged bottom shelf.

14. The desk organizer of claim 13, wherein the outward angle is about 4 degrees.
